(19) United States
(12) Patent Application Publication
(10) Pub. No.: US 2010/0018890 A1
(43) Pub. Date: Jan. 28, 2010

(54) SUPPORT ASSEMBLY AND METHOD OF USE

(76) Inventor: Michael T. Whitman, Loogootee, IN (US)

Correspondence Address: CRANE NAVAL SURFACE WARFARE CENTER;OFFICE OF COUNSEL, BUILDING 2, 300 HIGHWAY 361, CRANE, IN, 47552, US

(21) Appl. No.: 12/333,663

(22) Filed: Dec. 12, 2008

Related U.S. Application Data
(60) Provisional application No. 61/082,609, filed on Jul. 22, 2008.

(51) Int. Cl. B65D 81/02; B23P 17/00

(52) U.S. Cl. 206/521; 29/422

(57) ABSTRACT

An improved support assembly comprises a layered construction comprising a main body sandwiched between upper and lower covers. Each layer of the support assembly may receive and support at least one device. A method of use and manufacture of the support assembly are also provided.

This application claims priority to and the benefit of U.S. Provisional Patent Application No. 61/082,609, filed 22 Jul. 2008, the disclosure of which is now expressly incorporated herein by reference.

### STATEMENT REGARDING FEDERALLY SPONSORED RESEARCH OR DEVELOPMENT

The invention described herein was made in the performance of official duties by an employee of the Department of the Navy and may be manufactured, used, licensed by or for the United States Government for any governmental purpose without payment of any royalties thereon.

### FIELD OF THE INVENTION

The present invention relates generally to a support assembly, and more specifically to a layered or multi-tiered support system.

### BACKGROUND OF THE INVENTION

Items are transported in various containers, to include containers for specialized care, such as for example the extra care needed to protect sensitive equipment from damage during transport or storage. For example and without limitation, sensitive electronic equipment such as for example a gyroscope, may need to be handled using special care. It is known to use a single-tier support assembly for the specialized transport of a gyroscope and other such sensitive devices. Single-tier support assemblies generally consist of a top and bottom portion and are designed to transport one or two devices only. In addition, these two-piece support systems are known to use a polyurethane (P.U.) foam, similar to sofa padding (e.g., Stathane 8201-2SEH). Such polyurethane foam deteriorates from exposure to UV light and moisture, and the material flakes off when contacted. This type of foam is also deemed a hazardous material, and requires special precautions to mold the foam into the desired shape or form for use as a support system. In short, special processes and safety precautions must be used, and expensive molds have to be designed and built, to manufacture such polyurethane support systems. What is needed is an improved support system that is easier, safer and more economical to manufacture while supporting more devices in the same volume. It is also desired to use material that does not degrade with exposure to light, and does not flake off with contact. In addition, it is desired to eliminate the hazardous process of molding the support material.

### SUMMARY OF THE INVENTION

The present invention may comprise one or more of the following features and combinations thereof.

An illustrative support assembly generally comprising: a main body, a first cover and a second cover is provided along with a method of use and manufacture. The main body illustratively defines a first main cavity and an opposing second cavity. The first cover defines a first cover cavity and the second cover defines a second cover cavity, wherein the first and second covers are configured to sandwich therebetween the main body such that the first cover cavity generally aligns with the first main cavity adjacent and opposite thereto and the second cover cavity generally aligns with the second main cavity adjacent and opposite thereto, the aligned cavities configured to cooperate to receive and nestle therein a device.

Also provided is a method of supporting a device comprising the steps of: providing a main body defining an upper main cavity and a lower main cavity, providing an upper cover defining an upper cover cavity, providing a lower cover defining a lower cover cavity, receiving and nestling a device partially within one of the main cavities and partially within one of the cover cavities complimentary thereto; and joining together the main body and the cover.

Further provided is a method of manufacturing a support assembly comprising the steps of: cutting a first thickness of material into a desired shape including a first cavity, cutting a second thickness of material into a desired shape including a second cavity generally complimentary to the first cavity if the first and second thicknesses of material are stacked together with the first and second cavities in opposing fashion, and conditioning the material.

These and other objects of the present invention will become more apparent from the following description of the illustrative embodiment.

### BRIEF DESCRIPTION OF THE DRAWINGS

FIG. 1 is a perspective view of an illustrative support assembly.

FIG. 2 is an exploded view of the illustrative support assembly of FIG. 1.

FIG. 3 is a perspective view of a first cover of the illustrative support assembly of FIG. 1.

FIG. 4 is a perspective view of a main body of the illustrative support assembly of FIG. 1.

FIG. 5 is a perspective view of a second cover of the illustrative support assembly of FIG. 1.

FIG. 6 is a perspective view showing a heat exchanger having the illustrative support assembly nested therein, the heat exchanger being received within a container.

### DESCRIPTION OF THE ILLUSTRATIVE EMBODIMENTS

For the purposes of promoting an understanding of the principles of the invention, reference will now be made to a number of illustrative embodiments illustrated in the drawings and specific language will be used to describe the same.

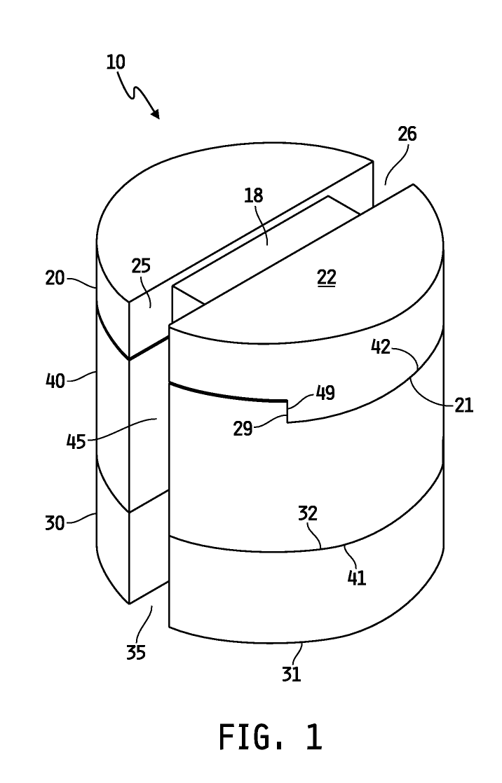

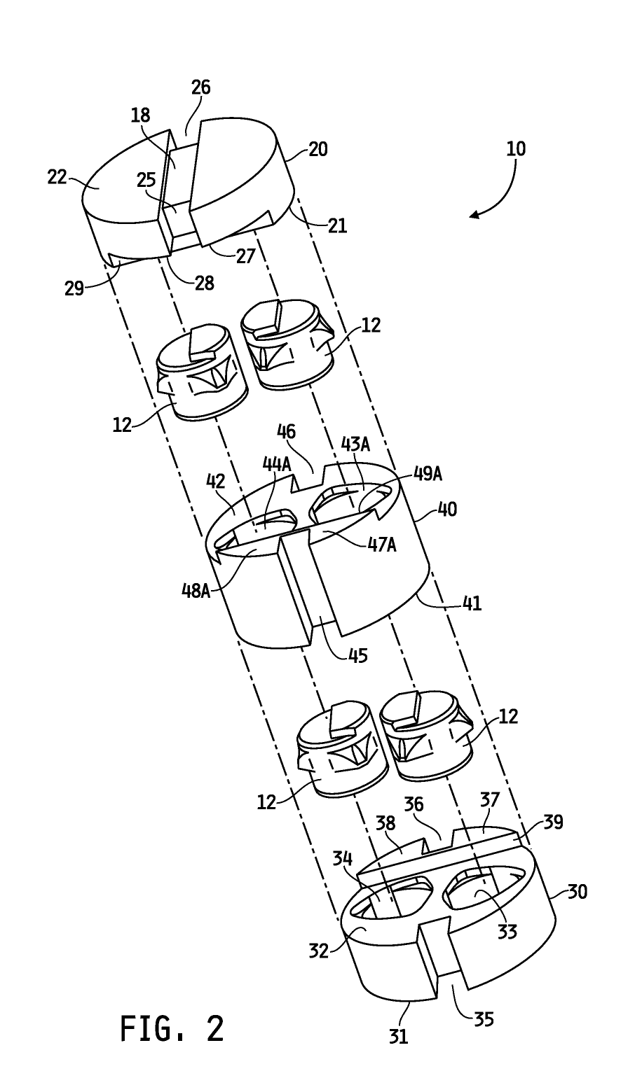

Referring to FIGS. 1-2 an illustrative support assembly is shown. As best seen in FIG. 2, the support assembly illustratively comprises a main body 40, a first or upper cover 20, and a second or lower cover 30.

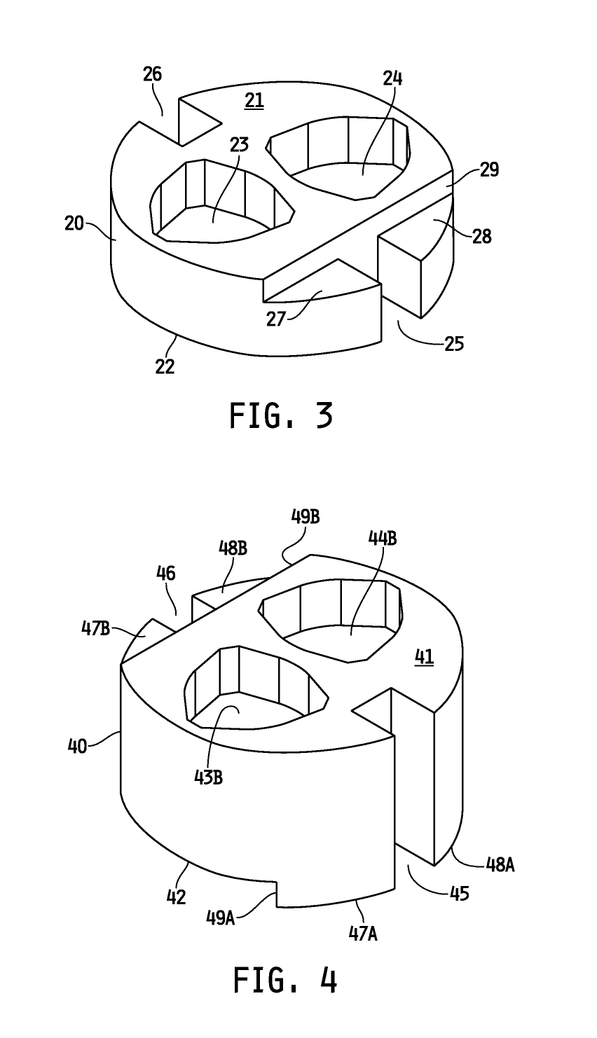

Referring to FIG. 3, the first or upper cover 20 illustratively comprises an inner face 21 and a spaced apart or opposing outer face 22. A pair of upper cover recesses or cavities 23 and 24 open through the inner face 21 and extend away therefrom toward the opposing outer face 22. The cover 20 has a generally circular shape or cylindrical cross section. The cover defines a trough 18 illustratively extending through the outer 22 and side 25, 26 faces or surfaces of the cover 20. Further defined are mating faces or shelves 27, 28, 29.

Referring to FIGS. 2 and 4, the main body 40 illustratively comprises lower face 41 and a spaced apart or opposing upper face 42. As best seen in FIG. 2, a pair of upper main recesses or cavities 43A, 44A open through the upper face 42 and extend away therefrom toward the opposing lower face 41. As best seen in FIG. 4, a pair of lower main recesses or cavities 43B, 44B open through the lower face 41 and extend away therefrom toward the opposing upper face 42. Illustratively, though not necessarily, the upper pair of cavities is generally aligned with the lower pair of cavities. The upper and lower cavities illustratively are not, although they may be in communication with one another such that four discrete cavities 43A, 43B, 44A, 44B are formed in the main body 40. The main body 40 has a generally circular shape or cylindrical cross section. The main body defines a trough illustratively extending through the side faces or surfaces 45, 46. Further defined are mating faces or shelves 47A, 48A, 49A, 47B, 48B, 49B.

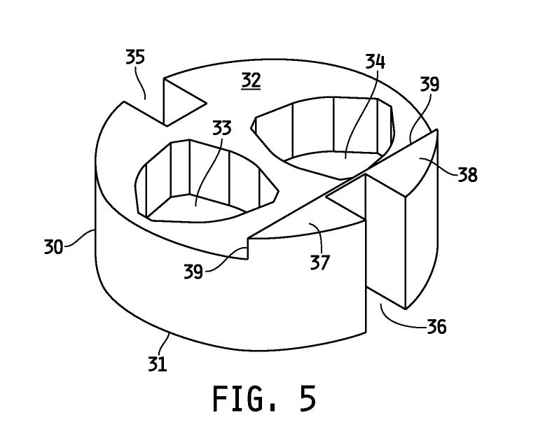

Referring to FIG. 5, the second or lower cover 30 illustratively comprises an inner face 32 and a spaced apart or opposing outer face 31. A pair of lower cover recesses or cavities 33 and 34 open through the inner face 32 and extend away therefrom toward the opposing face 31. The cover 30 has a generally circular shape or cylindrical cross section. The cover 30 defines a trough illustratively extending through the outer 31 (not shown) and side 35, 36 faces or surfaces of the cover 30. Further defined are mating faces or shelves 37, 38, 39.

As seen in FIGS. 1 and 2, the assembly may be assembled together by stacking the upper cover 20, main body 40 and lower cover 30 components such that the main body 40 is sandwiched between the upper cover 20 and the lower cover 30. When the assembly components 20, 30, 40 are stacked, the respective inner and upper and inner and lower faces and the respective mating faces are adjacent to one another and form a two-layer or two-tier support assembly. For example, the upper cover inner face 21 and the main body upper face 42 are oriented toward and adjacent to one another. Similarly, inner face 32 and lower face 41 are oriented toward and adjacent to one another. The various mating surfaces are also adjacent to one another when the components 20, 30, 40 are stacked or joined together. So, upper mating faces 27, 28 and 29 and main body mating faces 47A, 48A and 49A mate with or abut one another, as do lower mating faces 37, 38 and 39 and main body mating faces 47B, 48B and 49B. In addition, when the components 20, 30, 40 are stacked, their respective opposing and adjacent cavities are generally aligned with one another to form a generally closed recess or cavity configured to completely nestle therein a desired device illustratively with an interference type of fit. For example, upper cover cavity 23 and upper main cavity 43A, upper cover cavity 24 and upper main cavity 44A, lower cover cavity 33 and lower main cavity 43B, and lower cover cavity 34 and lower main cavity 44B, are respectively opposite and adjacent to one another and generally aligned. Illustratively, when the components 20, 30, 40 are stacked, these opposite and adjacent, or complementary cavity pairs 23 and 43A, 24 and 44A, 33 and 43B and 34 and 44B, cooperate to form respective discrete, generally closed recesses, cavities or compartments that may receive and nestle therein a device, for example a gyroscope. By nestle it is meant that the device is held snugly by an interference fit as by for example the foam exerting a pressure against the device received within any one of the cavities, both by the individual cavities, and by the complementary cavity pairs. Illustratively, these complementary cavity pairs cooperate such that part of the device is within the main body cavity and part is within the respective opposing and adjacent cover cavity. It will be appreciated; however, that the assembly could be designed so that the main body is thick enough to house the entirety of each device within the main body's respective cavities. In such a case, the covers would just seal the tops of each of the cavities and would not themselves need cover cavities. Alternatively, the devices could be fully contained within cover cavities, with the main body serving to close the respective upper and lower cavities. So, too, some combination of the above would fall within the scope of the disclosure. Finally, the binding trough 18 through each of the respective sides 22, 25, 26, 32, 35, 36, 45, 46 is generally aligned in uninterrupted or generally continuous communication about the periphery of the device and configured to receive therein a binding member such as for example a strap (not shown). Illustratively, the binding member holds the components 20, 30, 40 in stacked or joined relationship, although it will be appreciated that other means of joining the components together may be used including for example and without limitation, snaps, hooks, hasps, hook and pile, zippers, adhesive and the like.

It will be appreciated that in the illustrative embodiment, as few as one or as many as four gyroscopes or other device(s) may thus be received and nestled in the layered assembly 10. If desired, the assembly components 20, 30, 40 could be sized to define only a single, or more than two cavities per layer, component or tier. So, too, the illustrative cavities depicted in the drawings could be sized to allow for fewer or additional cavities per layer, component, or tier and to accommodate different size devices. Those skilled in the art will further appreciate that while the illustrative embodiment depicts two tiers, additional tiers may be added. For example and without limitation, upper cover 20 could define cavities in its outer face and another cover (not shown) could be added with corresponding cavities that would cooperate therewith to receive additional gyroscopes. A three-tier assembly would thus be formed. A four-tier assembly, and so on, could also be formed as desired.

Illustratively, the support assembly 10 is made from polyethylene foam, although other suitable material may be used. Suitable material illustratively will not produce significant off-gassing. One such suitable foam includes a polyethylene foam sold under the trademark EPERAN. EPERAN illustratively comprises a Class A, non-abrasive polyethylene, that has improved wear and environmental characteristics, and is readily available in various colors and densities. Like other polyethylene foams, EPERAN also maintains it surface texture, and does not flake off to any significant extent. Additionally, EPERAN is a non-abrasive material, so it will not scratch the equipment, device(s) or container(s) during use. Illustratively, while the material can be molded, it can also be cut to the desired specifications including the desired shape, size and dimensions. One suitable method of cutting material into the desired shape(s) includes water cutting. The ability to cut the material illustratively eliminates hazardous aspects of, and special safety equipment used in the heretofore used molding process. The cavities may also be cut to the desired shape and size. The components and their respective cavities may also be formed through a combination of cutting and joining together, for example with adhesives, heat, or other suitable joining means, various pieces. For example, one or more thicknesses of material may be cut into one or more desired shapes. These thicknesses or pieces may be joined together with an adhesive, for example and without limitation a pressure sensitive adhesive such as FT 8328, or other suitable means, to form the desired internal and external geometries of the support assembly components. The assembly illustratively may then be treated to condition the material. For example, the material may be baked at a suitable temperature, for example 140° F. to 150° F., for a suitable amount of time, for example, 20 to 40 hours, to condition the material. In one illustrative embodiment, it may be baked at 145° F. for 30 hours. One suitable means of cutting comprises water or water-jet cutting, although laser cutting, air cutting, chemical cutting, and blade cutting and the like may also be used. Illustratively, the cavities 23, 24, 33, 34, 43A, 43B, 44A, 44B, may comprise any shape, regular or irregular, and size suitable to receive, nestle, support and generally stabilize the device to be received therein through an interference fit. Similarly, although the illustrative embodiment is generally cylindrical, any suitable shape may be used. Because the material may be cut, rather than having to use a mold to form the components, which molding process may be expensive and which confines the support to shapes according to the mold, the illustrative support assembly illustratively may be relatively easily and cheaply manufactured. In addition, the support assembly may be modified relatively easily to accommodate supporting therein different devices, even within the same assembly, and/or being received within different containers. Unlike in the case of a molded material, which requires that a mold insert must be redone or fashioned anew to accommodate changes to the supporting assembly's structure, here, the cutting, which may for example be computer controlled, need only be changed. Thus, the illustrative device and methods of use and manufacture described herein can be utilized for other military gyroscopes and sensitive devices that require shipment in the same manner as described herein. The same material and process can be utilized, with revisions to the computer model to account for the different internal and/or external geometry.

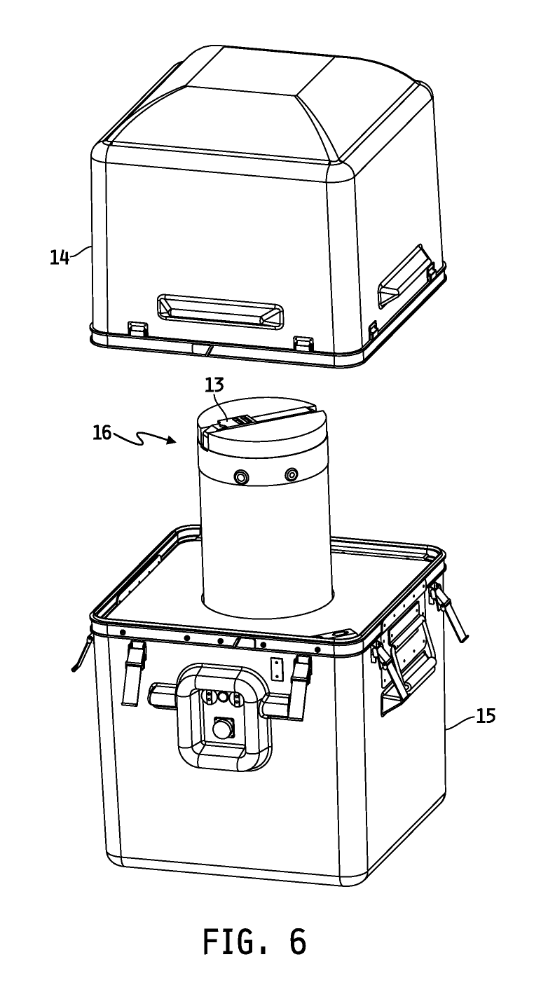

In use, as illustrated in FIG. 6, the support assembly 10 illustratively may be received within another container, for example a heater, heater assembly, or heat exchanger 16 having binding strap 13, which in turn may be received within a shipping or storage container illustratively comprising upper 14 and lower 15 portions. Of course, the support assembly 10 could be received directly within the container 14, 15. One end of a device to be supported illustratively would be received within one of the main body cavities and the other end of the device illustratively would be received within the corresponding cover cavity. Additional devices similarly could be received within complementary opposing cavity pairs. Illustratively, the heater may regulate the temperature of the support assembly and any device received therein.

It will be appreciated that the components and their respective recesses or cavities, may be fashioned into any desired shape having any desired dimensions. Such sizes and shapes may be determined by the device to be supported. For example, the internal cavities may be strategically sized and placed to maximize protection and capacity in the volume of the support assembly. In addition, the support assembly may be fashioned to fit inside another container, in which case the outer geometry of the support assembly illustratively would be sized and shaped to fit within any such container. For example, the illustrative support assembly, which will receive and nestle, cradle or support one to four gyroscopes, may itself be received within another container, for example a heat exchanger or heater assembly. So, too, the support assembly could be received directly into a shipping or storage container. In one illustrative embodiment, the support assemble is received within a heater assembly or container, which in turn is received within a shipping or storage container. In any event, the support assembly, alone or in combination with one or more containers within which it may be received, illustratively provides any device received and nestled therein, support, insulation from the ambient environmental conditions (e.g., temperature, moisture, precipitation, wind, radiation, and the like), as well as shock and vibration mitigation during storage and/or transport. In one illustrative example, one or more gyroscopes may be received within the support assembly and held or fastened together in a layered or stacked relationship with a binding member, such as for example and without limitation a metal strap. The support assembly may then be inserted into or received within another container, such as for example a heat exchanger, which in turn may be inserted or received in another container, such as for example a shipping or storage container. The heater illustratively regulates the temperature of the device at some desired temperature. For example, the heater may keep the interior of the heat exchanger at a temperature of about 100° F. to about 160° F., or some other desired temperature such as for example 145° F. Illustratively, the improved support assembly is generally cylindrical to fit inside existing heat exchanger assemblies. It will be appreciated; however, that the support assembly may be fashioned into other shapes, both regular and irregular, as desired. As noted, the illustrative layered embodiment allows the improved support assembly to be received within existing heater assemblies and/or shipping containers. Although the improved support assembly may be received within existing heaters/containers, its layered design allows it to receive and support additional devices than can be received within the support assemblies currently being received within those same existing heater assemblies and/or shipping containers.

While the invention has been illustrated and described in detail in the foregoing drawings and description, the same is to be considered as illustrative and not restrictive in character, it being understood that only illustrative embodiments thereof have been shown and described and that all changes and modifications that come within the spirit of the invention are desired to be protected.

What is claimed is:

1. A support assembly comprising:
a main body defining a first main cavity and an opposing second main cavity,
a first cover defining a first cover cavity, and
a second cover defining a second cover cavity;
wherein the first and second covers are configured to sandwich therebetween the main body such that the first cover cavity generally aligns with the first main cavity adjacent and opposite thereto and the second cover cavity generally aligns with the second main cavity adjacent and opposite thereto, the aligned cavities configured to cooperate to receive and nestle therein a device.

2. The support assembly of claim 1 wherein the assembly is fashioned from a material comprising foam wherein the foam is adapted to exert a pressure on the device received within the cavities.

3. The support assembly of claim 2 wherein the foam emits no significant flammable off-gasses, resists flaking, and is formable by cutting.

4. The support assembly of claim 2 wherein the material comprises polyethylene.

5. The support assembly of claim 2 wherein the main body, the first cover and the second cover are each formed by cutting a thickness of the material to desired dimensions.

6. The support assembly of claim 5 wherein the cutting is accomplished by water-jet cutting.

7. The support assembly of claim 6 wherein the cut pieces are joined together with an adhesive to form each of the main body, the first cover and the second cover and their respective cavities.

8. The support assembly of claim 2 wherein the assembly has a generally cylindrical shape.

9. The support assembly of claim 1 wherein the assembly further comprises a binding trough formed in at least a portion of each of the main body, the first cover and the second cover.

10. The support assembly of claim 9 wherein the assembly further comprises a binding member that cooperates with the trough to hold the assembly in stacked relationship.

11. The support assembly of claim 10 wherein the trough is formed through outer and side faces of the first cover, through side faces of the main body, and through outer and side faces of the second cover, and wherein each of the troughs generally align when the main body is sandwiched between the first and second covers to form a generally cylindrical assembly with the trough running generally uninterrupted around the outside portion of the assembly and wherein the binding member comprises a strap configured to be received within the trough.

12. The support assembly of claim 1 wherein the main body includes a pair of spaced-apart opposing faces, and wherein the first main cavity opens through one of the opposing faces and extends toward the other opposing face and the second main cavity opens through the other opposing face and extends toward the first said opposing face, and wherein the main body further defines at least one other main cavity opening through the first said opposing face separate from the first main cavity and further defines at least one other main cavity opening through the other opposing face separate from the second main cavity.

13. The support assembly of claim 12 wherein:
the first cover comprises a first inner face and a spaced apart first outer face, the first cover cavity opening through the first inner face and extending toward the first outer face; and
the second cover comprises a second inner face and a spaced apart second outer face, the second cover cavity opening through the second inner face and extending toward the second outer face; and
wherein the first cover further defines at least one other first cover cavity opening through the first inner face and extending toward the first outer face; and
wherein the second cover further defines at least one other second cover cavity opening through the second inner face and extending toward the second outer face; and
wherein the at least one other first cover cavity generally aligns with the at least one other main cavity opening through the first said opposing face and the at least one other second cover cavity generally aligns with the at least one other main cavity opening through the other opposing face when the main body is sandwiched between the first and second covers.

14. The support assembly of claim 1 wherein the opposing cover and main cavities cooperate to receive therein a device and nestle the device with an interference fit such that the cavities exert a pressure against the device.

15. The support assembly of claim 1 wherein the assembly is configured to be received within a heat exchanger.

16. The support assembly of claim 15 wherein the heat exchanger is configured to be received within a container.

17. A support assembly comprising:
a main body defining a plurality of upper main cavities and a plurality of lower main cavities,
an upper cover defining a plurality of upper cover cavities, and
a lower cover defining a plurality of lower cover cavities, and
wherein the upper and lower covers are configured to sandwich therebetween the main body such that the upper cover cavities generally align with the upper main cavities adjacent thereto and the lower cover cavities generally align with the lower main cavities adjacent thereto, and
wherein the aligned upper cover and main cavities and the aligned lower cover and main cavities cooperate to receive therein a device and nestle the device with an interference fit, and
wherein the assembly is fashioned from a material that exerts a pressure against the device, that resists flaking, that is formable by cutting, and that emits no significant flammable off-gasses.

18. The support assembly of claim 17 wherein the material comprises polyethylene.

19. A method of supporting a device comprising the steps of:
providing a main body defining an upper main cavity and a lower main cavity,
providing an upper cover defining an upper cover cavity,
providing a lower cover defining a lower cover cavity,
receiving and nestling a device partially within one of the main cavities and partially within one of the cover cavities complimentary thereto; and
joining together the main body and the cover.

20. The method of claim 19 further comprising the steps of:
receiving the assembly within a heat exchanger; and
receiving the heat exchanger within a container.

21. A method of manufacturing a support assembly comprising the steps of:
cutting a first thickness of material into a desired shape including a first cavity,
cutting a second thickness of material into a desired shape including a second cavity generally complimentary to the first cavity if the first and second thicknesses of material are stacked together with the first and second cavities in opposing fashion, and
conditioning the material.

22. The method of manufacture of claim 21 wherein the conditioning step comprises the step of baking the material at about 145° F. for about 30 hours.
